(19) United States
(12) Patent Application Publication
(10) Pub. No.: US 2012/0123891 A1
(43) Pub. Date: May 17, 2012

(54) PROFESSIONALLY-QUALIFIED BIDDING SYSTEM FOR A USER SEEKING PROFESSIONAL SERVICES

(76) Inventor: Neilesh Shashikant Patel, Los Altos, CA (US)

(21) Appl. No.: 13/091,098

(22) Filed: Apr. 20, 2011

Related U.S. Application Data
(63) Continuation-in-part of application No. 12/945,569, filed on Nov. 12, 2010.
(60) Provisional application No. 61/445,038, filed on Feb. 22, 2011.

(51) Int. Cl. G06Q 30/00

(52) U.S. Cl. 705/26.2; 705/26.3

(57) ABSTRACT

A professionally-qualified bidding system for a user seeking professional services is presented. The teachings are generally related to a professionally-qualified bidding system for a user seeking professional services. From the user perspective, the system generally includes a component operable for receiving a user's request for a professional service, an optional component operable to verify the user's request, a component operable for a viewing of the user's request by a qualified professional service provider, and a component for communicating a bid from the professional service provider to the user. In some embodiments, the user's request can be verified through one or more questionnaire's, or a submission from the user. In some embodiments, the professional service provider is qualified automatically. And, in some embodiments, the bid can be updated to provide the user with a real-time, or near real-time, status of the professional service provider's offer or counteroffers.

### CROSS-REFERENCE TO RELATED APPLICATIONS

This application is a continuation-in-part of U.S. application Ser. No. 12/945,569, filed Nov. 12, 2010, and claims the benefit of U.S. Provisional Application No. 61/445,038, filed Feb. 22, 2011, each application of which is hereby incorporated herein by reference in its entirety.

### BACKGROUND OF THE INVENTION

1. Field of the Invention

The teachings generally relate to a professionally-qualified bidding system for a user seeking professional services.

2. Description of the Related Art

There is a problem with regard to the price of professional services that a user seeking those services must pay. One problem is the access to the professional service providers, as many are not readily available in standard “Yellow Pages” searches, or even mainstream electronic search engines. Another problem is with regard to obtaining a reference or rating regarding a particular professional, at least to the extent that a consumer feels comfortable with any particular selection of a professional, as the selection of provider can certainly have a direct bearing on the quality of service. Another problem is with regard to the pricing of the service, particularly with regard to the quality or value obtained from the pricing. Another problem is with regard to the research time required to make the user feel comfortable with a particular selection of service provider. All too often, a user must simply choose a provider from a limited selection without any reference, rating, idea of an appropriate price, or an otherwise informed position that would come from proper research. Because of this, the user of the professional service typically feels that they lack in an effective bargaining position. The combination of the recent collapse of the worldwide economy and the user's fear and apprehension of regarding professional services has resulted in professional service providers providing fewer services than ever before.

The healthcare industry is a classic example of the problems discussed above. Health care prices have become increasingly unaffordable to the uninsured and underinsured. Fear of costs, lack of knowledge, and lack of control over pricing are among the several major problems for consumers of health care, particularly since a user's substantial reliance on insurance coverage and the assistance of the insurance company professionals has been the traditional paradigm but is now appears to be evolving into a thing of the past.

With the recent Affordable Care Act, which passed in the United States on Mar. 23, 2010, a new group of underinsured patients are soon to stem. Elective procedures have become increasingly expensive, and patients are losing access to such procedures that can enhance or improve their quality of life. At the same time, doctor's and other health providers have found themselves underutilized, and many health clinics around the country have gone out of business over the last few years. It should be appreciated that any health providers would be willing to lower their fees, at least periodically, when they are slow or wish to pick up extra business. Thus, a system, which allows health service pricing to fluctuate depending on the supply/demand of individual clinics would appreciated by those of skill in the art.

What is needed is a system for, and method of, negotiating for a professional service in a free market environment. Professionals would appreciate a negotiation system that doesn't require that they show price lists for public review, as they have often opined that opening up their price lists for public viewing would be “demeaning.” Likewise, the public would appreciate a system that avoids anything resembling “price fixing.” Such systems would be highly desirable in the internet environment, for example, particularly if accessible through any device, whether fixed, portable, or handheld. Users of the system could have the tools to obtain, for example, a provider search and validation, insurance verification, payment, negotiation of a price with the provider, comparison shopping, provider qualification information, scheduling of the service, appointment reminders, and an opportunity to provide and review feedback from other users regarding the procedure, the provider, and the administration of the service by office staff. Moreover, service providers need a such a system that also filters requests for bids that are not qualified, meaning that the user has not confirmed or otherwise “qualified” the need or desire for a particular service through a professional service provider prior to requesting bids through the system

As such, those skilled in the art would appreciate a system that provides at least (i) increased access to professional service providers; (ii) a reference or rating regarding a particular professional; (iii) an understanding of the pricing of the service, particularly with regard to the quality or value obtained from the pricing; as well as (iv) a research hub, or service-assessment database, that is easy to use and provides the information desired to help make the user feel comfortable with a particular selection of service provider and procedure. Moreover, the users of the professional services typically would appreciate obtaining (v) an effective bargaining position, and the service providers would appreciate (vi) a system that qualifies a user's request for services before allowing the user to request bids.

### SUMMARY

The teachings are generally related to a professionally-qualified bidding system for a user seeking professional services, as well as for professional service providers seeking users in need of their services. From the user perspective, the system generally includes a component operable for receiving a user's request for a professional service, an optional component operable to verify the user's request, a component operable for a viewing of the user's request by a qualified professional service provider, and a component for communicating a bid from the professional service provider to the user. In some embodiments, the user's request can be verified or made more specific through one or more questionnaire's, or a submission from the user. In some embodiments, the professional service provider is qualified automatically. And, in some embodiments, the bid can be updated to provide the user with a real-time, or near real-time, status of the professional service provider's offer or counteroffers. From the service provider perspective, the system is similar, but the service provider may have other options, such as the ability to update an offer or counteroffer and provide the user with the update real-time or near real-time.

As such, the teachings are directed to a professionally-qualified bidding system for a user seeking professional services. The system can comprise a processor, an input device, a user-profile module, a service assessment database, an alignment module, a solutions module, an integration engine, a bidding module, and an output device.

In some embodiments, the input device can be operable for accepting user-oriented data. The user-oriented data can include (i) a personalized user-profile and (ii) a professional-qualifier to qualify a user's request for a professional service from a service provider. The user-oriented data can include information from answers to a template questionnaire from the user, and an identification of the professional service sought by the user.

In some embodiments, the user-profile module can be embodied in a non-transitory computer readable storage medium for receiving the user-oriented data. Likewise, the service-assessment database can be embodied in a non-transitory computer readable storage medium and comprise a library of service-related information containing information relevant to the professional service requested by the user

In some embodiments, the alignment module can be embodied in a non-transitory computer readable storage medium for aligning the user-oriented data with professional-oriented data and the service-related information from the service-assessment database. Likewise, the solutions module can be embodied in a non-transitory computer readable storage medium for parsing the service-related information into information subsets that include a risk subset for establishing an indvidiaul and collective risk measurement(s) of the service(s) sought by the user.

In some embodiments, the integration engine can be embodied in a non-transitory computer readable storage medium for (i) integrating information between the information subsets; (ii) identifying any conflicting information; and (iii) compiling data comprising the integrated information and any conflicting information into an assessment format for the user. Likewise, the bidding module can be embodied in a non-transitory computer readable storage medium for converting the compiled data into a bidding format for use by the user.

In some embodiments, the output device can be operable for displaying the service-related information to the user. And, in some embodiments, the professional qualifier can provide the professional with an available pre-screening data regarding the user's need for the service, as well as optionally provide an estimate of, or basis for determining, the risk of performing the service.

In some embodiments, the professional qualifier can be from a third-party professional. And, in some embodiments, the assessment format includes information designed to assist the user in understanding a response from a service provider. Moreover, in some embodiments, the assessment format includes a service appraisal checklist.

In some embodiments, the bidding format can include the service requested and the risk measurement for the service requested. And, in some embodiments, the user-oriented data can include a time limit for the service provider to respond to the user.

The professional service can be any service that requires the performance of a qualified professional service provider. For example, the professional service can be a health service, and the professional qualifier can be provided by a licensed healthcare professional. In some embodiments, however, it should be appreciated that a professional qualifier could comprise an assessment by a unlicensed healthcare professional that has the expertise to provide such an assessment, but only if the law in the relevant jurisdiction allows the procedure to be performed by an unlicensed health professional.

In some embodiments, the user-oriented data can comprise one or more of the subject's age, sex, height, weight, known medical conditions, contraindications to treatment, vital signs, test results, prior conditions, prior treatments, lifestyle habits (smoking, alcohol), current and past medications, prescriptions, and family medical history. Likewise, in some embodiments, the system can comprise a data exchange module embodied in a non-transitory computer readable storage medium for interacting with external medical data formats, wherein the user-oriented data can comprise external medical data obtained from a health provider's database. And, in some embodiments, the system can further comprise an external computer connection and a browser program module embodied in a non-transitory computer readable storage medium, wherein the browser program module accesses external data through the external computer connection to update the service-assessment database.

The performance of professional services can sometimes require that information about the user or service remain confidential. In such embodiments, there can be security measures to protect the subject's privacy, integrity of data, or both.

The system can be a software-based service. It should be appreciated that the software can be purchased on a tangible medium, downloaded, or simply accessed in a streaming version from a cloud-computing space. And, it should be further appreciated that, in some embodiments, neither the user nor the service provider need to have more than minimal computing capability. As such, in some embodiments, the system is provided over a network. And, in some embodiments, the system is coupled to a network.

The user of the system can be any individual seeking services, and the services can be sought for the user or for another person or any entity. For example, in some embodiments, the user is a first individual requesting a professional service for a second individual, the user selected from the group consisting of a parent, guardian, case worker, professional service provider, or an insurance provider. To illustrate further, in some embodiments, the user can be a first professional that assesses the need for another person or entity, and the first professional can use the system to seek the services of a second professional. It should be appreciated that an “entity” can be any legal entity, including a person or corporate entity, for example. In some embodiments, the user of a professional service can be an animal in need of veterinary or other professional services that can be performed on an animal, such as a dog, cat, horse, cow, other farm animal or pet, and the like.

It should be appreciated that a user may not always have a qualified request for a service. In these embodiments, the system can provide a systematic method to provide a professional service provider with such a qualified request through the use of questionnaires, for example. In some embodiments, the user indicates an absence of a professional qualifier; and, interactively and iteratively answers one or more additional queries generated by the system to develop a virtual, professional qualifier.

It should be appreciated that a user can gain access through any connection to the system. In some embodiments, the user is mobile, and the input device, the output device, or both, is provided through a portable, single unit device. And, in some embodiments, the device comprises a portable, single unit, handheld device. The handheld device can be, for example, a cell phone, smart phone, PDA, iPAD, laptop computer, and the like.

It should be appreciated that the system can be used from the perspective of the user or the professional service provider. In some embodiments, the professionally-qualified bidding system is for a professional service provider seeking a user of professional services. In these embodiments, the system can comprise a processor; an input device, a professional-profile module, a service-assessment database, an alignment module, a solutions module, an integration engine, a bidding module, and an output device.

The input device can be operable for accepting professional-oriented data including a professional-profile. The professional-oriented data can include professional qualification information, for example. The system can also include a professional-profile module embodied in a non-transitory computer readable storage medium for receiving the professional-oriented data.

The service-assessment database can be embodied in a non-transitory computer readable storage medium and comprise a library of service-related information containing information relevant to a professional service requested by a user. And, the system can include an alignment module embodied in a non-transitory computer readable storage medium for aligning the user-oriented data with professional-oriented data and the service-related information from the service-assessment database.

The solutions module can be embodied in a non-transitory computer readable storage medium for parsing the service-related information into information subsets that include a risk subset for establishing an individual risk measurement of the service sought by the user and a collective risk assessment of the service sought by the user. The collective risk assessment can be calculated among a variety of methods of parsing service-related information subsets and then joining them either mathematically (i.e. averaging risk assessments) or weighting and then averaging individual risk assessments to come to an overall risk assessment.

The integration engine can be embodied in a non-transitory computer readable storage medium for (i) integrating information between the information subsets; (ii) identifying any conflicting information; and (iii) compiling data comprising the integrated information and any conflicting information into an assessment format for the service provider. And, the bidding module can be embodied in a non-transitory computer readable storage medium for converting the compiled data into a bidding format for the service provider.

The output device can be operable for displaying the service-related information to the service provider. And, the professional qualifier can be used to provide the professional with an available pre-screening data regarding the user's need for the service, as well as optionally provide an estimate of, or basis for determining, the risk of performing the service.

From the standpoint of the professional service provider, the system can include any of the options available to the user as taught herein, however, the service provider can have other options that are not needed for use or viewing by the user. In one example, the assessment format can include information designed to assist the provider in forming an understandable response to the user. In another example, the professional-oriented data can include a flat rate for the service requested by the user. Of course, the user can accept the flat rate for any reason, where acceptance of the flat rate may be expected to expedite a performance of the service by the service provider. The service provider can also update an offer or counter offer, and the user can view the updated offer or counter. The user can receive a prompt from the system regarding such an update, and the prompt can be received “on-the-fly”, such that the update can be considered real-time, or near real-time.

The teachings are also directed to a professionally-qualified bidding system having (i) a user component operable to allow a user to request a bid from a service provider for a professional service, wherein the request includes a professional-qualifier to qualify the user's request for the professional service from the service provider; and, (ii) a professional component operable for the service provider to place the bid on the professional service sought by the user. The professional qualifier can be included to provide the professional with an available pre-screening data from a third-party professional regarding the user's need for the service and the risk of performing the service. And, as in many of the embodiments, the professional service can be any professional service that can be qualified and sought by a user including, but not limited to, a health service, in which the professional qualifier can be provided by a licensed healthcare professional in some embodiments.

### BRIEF DESCRIPTION OF THE FIGURES

FIG. 1 shows a general technology platform for the professionally-qualified bidding system, according to some embodiments.

FIG. 2 illustrates a processor-memory diagram to describe components of the professionally-qualified bidding system according to some embodiments.

FIG. 3 is a concept diagram illustrating the professionally-qualified bidding system according to some embodiments.

FIG. 4 is a diagram of the logic of the system for the personalized professionally-qualified bidding system according to some embodiments.

FIGS. 5A and 5B illustrate the basic concept of the system in the healthcare industry, according to some embodiments.

FIGS. 6A and 6B illustrate provider and patient pathways through the system, according to some embodiments.

FIG. 7 illustrates a transaction pathway between a user and service provider in the healthcare industry, according to some embodiments.

FIG. 8 illustrates an overview of the entire process as applied to the healthcare industry, according to some embodiments.

FIG. 9 shows how a network may be used for the personalized health information discovery and presentation system in some embodiments.

### DETAILED DESCRIPTION

The teachings are generally related to a professionally-qualified bidding system for a user seeking professional services, as well as for professional service providers seeking users in need of their services. From the user perspective, the system generally includes a component operable for receiving a user's request for a professional service, an optional component operable to verify the user's request, a component operable for a viewing of the user's request by a qualified professional service provider, and a component for communicating a bid from the professional service provider to the user. In some embodiments, the user's request can be verified through one or more questionnaire's, or a submission from the user. In some embodiments, the professional service provider is qualified automatically. And, in some embodiments, the bid can be updated to provide the user with a real-time, or near real-time, status of the professional service provider's offer or counteroffers. From the service provider perspective, the system is similar, but the service provider may have other options, such as the ability to update an offer or counteroffer and provide the user with the update real-time or near real-time.

The term “professional service” can refer to any service that requires the performance of a qualified professional service provider. In some embodiments, the qualified service provider must be licensed, registered, or otherwise certified in a manner in which the validity of the license, registration or certification can be readily confirmed by the system or any user of the system, such as the requester of services or any service provider. In some embodiments, the professional service can be a health service, and the professional qualifier can be provided by a licensed healthcare professional. In some embodiments, the professional service can be a health and beauty service, in which the service provider can be a professional cosmetologist, massage therapist, occupational therapist, physical therapist, kinesiologist, and the like.

The system can be a software-based service. It should be appreciated that the software can be purchased on a tangible medium, downloaded, or simply accessed in a streaming version from a cloud-computing space. And, it should be further appreciated that, in some embodiments, neither the user nor the service provider need to have more than minimal computing capability. As such, in some embodiments, the system is provided over a network. And, in some embodiments, the system is coupled to a network.

The user of the system can be any individual seeking services, and the services can be sought for the user or for another person or any entity. For example, in some embodiments, the user is a first individual requesting a professional service for a second individual, the user selected from the group consisting of a parent, guardian, professional service provider, or an insurance provider. To illustrate further, in some embodiments, the user can be a first professional that assesses the need for another person or entity, and the first professional can use the system to seek the services of a second professional. It should be appreciated that an “entity” can be any legal entity, including a person or corporate entity, for example. In some embodiments, the user of a professional service can be an animal in need of veterinary or other professional services that can be performed on an animal, such as a dog, cat, horse, cow, other farm animal or pet, and the like.

It should be appreciated that a user may not always have a qualified request for a service. In these embodiments, the system can provide a systematic method to provide a professional service provider with such a qualified request through the use of questionnaires, for example. In some embodiments, the user indicates an absence of a professional qualifier; and, interactively and iteratively answers one or more additional queries generated by the system to develop a virtual, professional qualifier.

As such, the teachings are also directed to a professionally-qualified bidding system having (i) a user component operable to allow a user to request a bid from a service provider for a professional service, wherein the request includes a professional-qualifier to qualify the user's request for the professional service from the service provider; and, (ii) a professional component operable for the service provider to place the bid on the professional service sought by the user. The professional qualifier can be included to provide the professional with an available pre-screening data from a third-party professional regarding the user's need for the service and the risk of performing the service.

A user can be qualified, via the professional-qualifier, using any method known to one in a profession offering the services desired by the user. In the health field, for example, treatment plans can be uploaded into the system by the patient or a service provider to assist in the qualification of the patient. This transmission can be handled by XML, OCR (optical character recognition) or other structured markup language to transfer the contents of a procedure list including but not limited to procedure billing code, procedure description, procedure quantity, proposed price and warranty terms and conditions by the practitioner or patient in an array. In some embodiments, the professional qualifier can provide the professional with an available pre-screening data regarding the user's need for the service, as well as optionally provide an estimate of, or basis for determining, the risk and ease of performing the service. In some embodiments, the professional qualifier can be from a third-party professional.

Likewise, the professionals can be qualified. The systems provided herein can be designed to include a professional qualification verification function that is operable to access proof of the professionals good standing. Public and private databases of malpractice information, licensee status or any other searchable database could be searched to check the status of any regulated industry licensee. For example, the system may interface directly with a national or state/local clearinghouse or databank reflecting any disciplinary action or practice stipulations relating to, for example, a physician's license to practice medicine.

In some embodiments, the system can also identify and provide users with adverse reports or otherwise adverse information. Such information may be available from organizations that compile such information regarding the professionals seeking to provide services through the systems taught herein. In some embodiments, the system provides a chat or blog function that allows users to discuss and/or rate their experience with a service provider both before and after their experience. And, in some embodiments, the system can include service provider rankings to users that are based on criteria that can include professional standing, professional recognition, level of experience, presence or absence of adverse reporting, user ratings, or a combination thereof.

In some embodiments, such professional services include medical, surgical, dental, chiropractic, kinesiology, nursing (home/travel), locum tenens health providers, dental therapists, dental hygienists, and the like. In some embodiments, such professional services and/or qualifier may include, a comprehensive health history questionnaire, x-rays, pulmonary function, vision screening, hearing tests, resting cardiogram, blood pressure, pulse, height and weight, blood and urine screening, blood chemistry, CBC, urinalysis, infectious disease screens, cancer screens, heavy metal screens, and the like. In some embodiments, the professional services and/or qualifier may include additional testing and training services, such as hearing conservation training, respiratory protection, respirator fit testing and training, drug screening programs, and the like. In some embodiments, the professional services and/or qualifier may include physician services, such as comprehensive hands-on physical examination, annual respirator medical evaluation, fitness for duty assessments, medical referrals, and the like.

In some embodiments, the professional services and/or qualifier may include wellness programs, such as health risk appraisal questionnaires, biometric screening (finger stick or venipuncture), body fat composition and BMI, guaiac stool screen (colon cancer screening), trend analysis, personal wellness and health coaching, and the like, where web based (online) and/or paper options may be available.

In some embodiments, the professional services and/or qualifier may include annual fitness evaluations, such as aerobic capacity including sub-maximal stress test (Gerkin Protocol), muscular endurance and strength (e.g., arms and legs), flexibility measurements (e.g., shoulder, trunk, and legs), exercise prescriptions, and the like. In some embodiments, the professional services and/or qualifier may include records management and reporting services, such as HIPAA-compliant reporting, web-based reporting, and the like.

In some embodiments, the professional services and/or qualifier may include surgical procedures, arm lift, body contouring after weight loss, body lift, botullinum toxin, hyaluronic acid, polylactic acid, calcium hydroxylapatite, PMMA (polymethylmethacrylate), laser skin surfacing, breast implant, breast reconstruction/augmentation, laser skin resurfacing, eyelash enhancement, laser and ultrasound-assisted liposuction, cellulite treatment, chemical peels, breast lift surgery, breast reduction for men, brow lift, chemical peel, chin surgery, dermabrasion, dermal fillers (calcium hydroxylapatite, collagen, hyaluronic acid, PMMA, polyalkylimide, polyactic acid), ear surgery, eyelid surgery, facelift surgery, facial implants, hair replacement, laser and ultrasound assisted liposuction, laser skin resurfacing, liposuction procedure, plastic surgery for men, microdermabrasion treatments, nose surgery, permanent makeup, skin rejuvenation and resurfacing, spider vein treatment, thigh lift, tummy tuck, cleft lip and palate repair, hand surgery, scar revision, skin cancer treatment, tissue expansion, body wraps, facials, massage, nails enhancement/grooming procedures, day spa treatments, bariatric surgery/weight loss surgery, mastectomy reconstruction, hand surgery, lip augmentation, fat fillers, brow lift, cheek implants, stem cell facelift, jaw implants, thread lift, otoplasty penile implants, calf implants, Brazilian butt lift, bra-line back lift, butt implants, bicep and tricep implants, vaginal rejuvenation implants, body lifts, and the like.

In some embodiments, the professional services and/or qualifier may include dermatological service, laser hair removal, laser tattoo, laser scar removal, laser skin resurfacing, micropigmentation, vibraderm, spider vein treatment, vitamins and natural healing, cellulite treatment, stretch marks, hair transplants, hair loss, hair transplants, hair loss, ophthalmology, cataract surgery, eyeglass fabrication, YAG posterior capsulotomy, multifocal implants, limbal relaxing incisions, LASIK, PRK, wavescan, intraocular lens implants, blepharoplast (eyelift), BOTOX injections, ptosis repair, thermage skin tightening, restylane injections, ectropion repair, entroprion repair, selective laser trabeculoplasty, trabeculectomy, lacrimal probe, punctual plugs, diabetic retinopathy laser, pterygium excision, chalazion excision, corneal topography, optical coherence tomography (OCT), visual field, glaucoma surgery/canoloplasty, refractive surgery of all types, corneal surgery of all types, vitreo-retinal surgery of all types, eye muscle surgery of all types, oculoplastic surgery of all types, and the like.

In some embodiments, the professional services and/or qualifier may include dental procedures, braces, crowns, bridges, dental implants, mini implants, tooth extraction, fillings, dental cleaning, teeth whitening, and the like. In some embodiments, the professional services and/or qualifier may include hair treatment procedures, hair cuts, shampoos and styling, coloring, highlighting, dual-dimension coloring, keratin smoothing system, karatin kiss express blowout, high gloss glazing, color correction, extra coloring, perms, deep conditioning treatment, straightening, lash tinting, brow tinting, eyebrow threading, neck trimming, facial shave, beard trimming. In some embodiments, the professional services and/or qualifier may include nail treatments, nail polish change, manicure, pedicure, French/Paraffino/Nailart hands, nail repair, full set, and the like.

As such, the teachings are directed to a professionally-qualified bidding system for a user seeking professional services. The system can comprise, for example, a processor, an input device, a user-profile module, a service assessment database, an alignment module, a solutions module, an integration engine, a bidding module, and an output device.

It should be appreciated that the system can be implemented from the perspective of the user or the professional service provider. In some embodiments, the professionally-qualified bidding system is for a professional service provider seeking a user of professional services. In these embodiments, the system can comprise a processor; an input device, a professional-profile module, a service-assessment database, an alignment module, a solutions module, an integration engine, a bidding module, and an output device.

The input device can be operable for accepting professional-oriented data including a professional-profile. The professional-oriented data can include professional qualification information, for example. The system can also include a professional-profile module embodied in a non-transitory computer readable storage medium for receiving the professional-oriented data.

The service-assessment database can be embodied in a non-transitory computer readable storage medium and comprise a library of service-related information containing information relevant to a professional service requested by a user. And, the system can include an alignment module embodied in a non-transitory computer readable storage medium for aligning the user-oriented data with professional-oriented data and the service-related information from the service-assessment database.

The solutions module can be embodied in a non-transitory computer readable storage medium for parsing the service-related information into information subsets that include a risk subset for establishing a risk measurement of the service sought by the user. It should be appreciated that the risk measurement can be made in more than one stage, in some embodiments. And, the professional can place an offer that is contingent upon a final evaluation of the user of the service. This can be of particular value, for example, where the virtual or any subsequent evaluation raised issues that (i) were of concern, (ii) were unresolved, or (iii) where additional information may be needed before finalizing the negotiation by performing the service. For example, a doctor may make an offer that is contingent upon meeting and discussing issues, such as risk issues, consent issues, compliance issues, tolerance issues, complication issues, and the like, with a patient before finalizing a negotiation. In some embodiments, this may be a contingency referred to as an extended-detailed screening. In some embodiments, the recipient of the service would not be financially responsible for the screening. Such screening can be performed online, as part of the systems taught herein, by teleconference, in writing, or by an in-person consultation. And, in some embodiments, the procedure and results from the screening can be input as data into the systems taught herein. It should be appreciated that, a professional could require such extended-detailed screening in every case, to mitigate risk and ensure reasonable economics of providing a service, for example, in some embodiments. In these embodiments, the professional would maintain the discretion to end or invalidate any negotiation based on any of a variety of criteria considered to be standard or reasonable criteria by a professional in the relevant art when considering taking responsibility for the performance of a service, or negotiating for the performance of a service, desired or needed by a user of the teachings provided herein. It should be appreciated that a service may be performed for the payment of an extra fee where the extended-detailed screening would otherwise negate performance of the service.

The integration engine can be embodied in a non-transitory computer readable storage medium for (i) integrating information between the information subsets; (ii) identifying any conflicting information; and (iii) compiling data comprising the integrated information and any conflicting information into an assessment format for the service provider. And, the bidding module can be embodied in a non-transitory computer readable storage medium for converting the compiled data into a bidding format for the service provider.

The output device can be operable for displaying the service-related information to the service provider. And, the professional qualifier can be used to provide the professional with an available pre-screening data regarding the user's need or eligibility for the service, as well as optionally provide an estimate of, or basis for determining, the risk, complication and ease of performing the service.

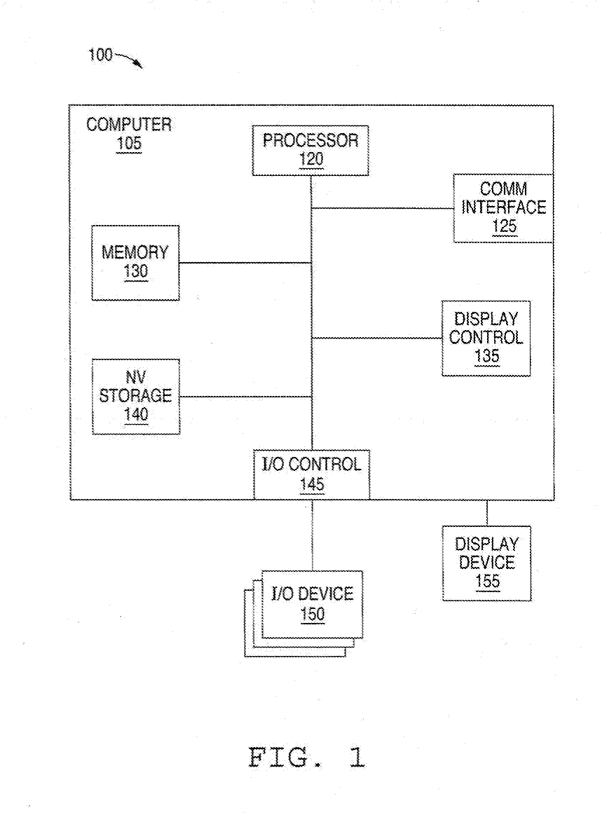

FIG. 1 shows a general technology platform for the information discovery and presentation system, according to some embodiments. The computer system 100 may be a conventional computer system and includes a computer 105, I/O devices 110, and a display device 115. The computer 105 can include a processor 120, a communications interface 125, memory 130, display controller 135, non-volatile storage 140, and I/O controller 145. The computer system 100 may be coupled to or include the I/O devices 150 and display device 155.

The computer 105 interfaces to external systems through the communications interface 125, which may include a modem or network interface. It will be appreciated that the communications interface 125 can be considered to be part of the computer system 100 or a part of the computer 105. The communications interface 125 can be an analog modem, isdn modem, cable modem, token ring interface, satellite transmission interface (e.g. “direct PC”), or other interfaces for coupling the computer system 100 to other computer systems. In a cellular telephone, this interface is typically a radio interface for communication with a cellular network and may also include some form of cabled interface for use with an immediately available personal computer. In a two-way pager, the communications interface 125 is typically a radio interface for communication with a data transmission network but may similarly include a cabled or cradled interface as well. In a personal digital assistant, the communications interface 125 typically includes a cradled or cabled interface and may also include some form of radio interface, such as a BLUETOOTH or 802.11 interface, or a cellular radio interface, for example.

The processor 120 may be, for example, a conventional microprocessor such as an Intel Pentium microprocessor or Motorola power PC microprocessor, a Texas Instruments digital signal processor, or a combination of such components. The memory 130 is coupled to the processor 120 by a bus. The memory 130 can be dynamic random access memory (DRAM) and can also include static ram (SRAM). The bus couples the processor 120 to the memory 130, also to the non-volatile storage 140, to the display controller 135, and to the I/O controller 145.

The I/O devices 150 can include a keyboard, disk drives, printers, a scanner, and other input and output devices, including a mouse or other pointing device. The display controller 136 may control in the conventional manner a display on the display device 155, which can be, for example, a cathode ray tube (CRT) or liquid crystal display (LCD). The display controller 135 and the I/O controller 145 can be implemented with conventional well known technology, meaning that they may be integrated together, for example. In some embodiments, the output device can be operable for displaying the service-related information to the user. It should be appreciated that the risk, complication and ease of performing the service can be assessed in any way considered acceptable to the profession, and this assessment method itself can be based on what is considered reasonable by the community standards for the professional, state standards for the professional, country standards for the professional, professional organization standards for the professional, or any combination thereof. To protect the users seeking services, in some embodiments, the system may qualify the level or type(s) of assessment that a professional service provider must follow. And, in some embodiments, the users seeking services and the providers providing services may be required to sign a waiver releasing any host, hosts, or network affiliates of the systems taught herein from liability associated with the performance of services obtained through the systems taught herein. In embodiments directed to healthcare, examples of risk assessment systems can include, but are not limited to, the ASA (American Society of Anesthesiologists physical status classification system) risk classification system for anesthesia, Brodsky Classification of Tonsillar Enlargement for pediatric dental oral conscious sedation risk, and the NYHA (New York Heart Association) risk classification system for cardiac risk.

The non-volatile storage 140 is often a FLASH memory or read-only memory, or some combination of the two. A magnetic hard disk, an optical disk, or another form of storage for large amounts of data may also be used in some embodiments, although the form factors for such devices typically preclude installation as a permanent component in some devices. Rather, a mass storage device on another computer is typically used in conjunction with the more limited storage of some devices. Some of this data is often written, by a direct memory access process, into memory 130 during execution of software in the computer 105. One of skill in the art will immediately recognize that the terms “machine-readable medium” or “computer-readable medium” includes any type of storage device that is accessible by the processor 120 and also encompasses a carrier wave that encodes a data signal. Objects, methods, inline caches, cache states and other object-oriented components may be stored in the non-volatile storage 140, or written into memory 130 during execution of, for example, an object-oriented software program.

The computer system 100 is one example of many possible t architectures. For example, personal computers based on an Intel microprocessor often have multiple buses, one of which can be an I/O bus for the peripherals and one that directly connects the processor 120 and the memory 130 (often referred to as a memory bus). The buses are connected together through bridge components that perform any necessary translation due to differing bus protocols.

In addition, the computer system 100 is controlled by operating system software which includes a file management system, such as a disk operating system, which is part of the operating system software. One example of an operating system software with its associated file management system software is the family of operating systems known as Windows CE® and Windows® from Microsoft Corporation of Redmond, Washington, and their associated file management systems. Another example of operating system software with its associated file management system software is the LINUX operating system and its associated file management system. Another example of an operating system software with its associated file management system software is the PALM operating system and its associated file management system. The file management system is typically stored in the non-volatile storage 140 and causes the processor 120 to execute the various acts required by the operating system to input and output data and to store data in memory, including storing files on the non-volatile storage 140. Other operating systems may be provided by makers of devices, and those operating systems typically will have device-specific features which are not part of similar operating systems on similar devices. Similarly, iOS, ANDROID, WinCE® or PALM operating systems may be adapted to specific devices for specific device capabilities.

The computer system 100 may be integrated onto a single chip or set of chips in some embodiments, and typically is fitted into a small form factor for use as a personal device. Thus, it is not uncommon for a processor, bus, onboard memory, and display/I-0 controllers to all be integrated onto a single chip. Alternatively, functions may be split into several chips with point-to-point interconnection, causing the bus to be logically apparent but not physically obvious from inspection of either the actual device or related schematics.

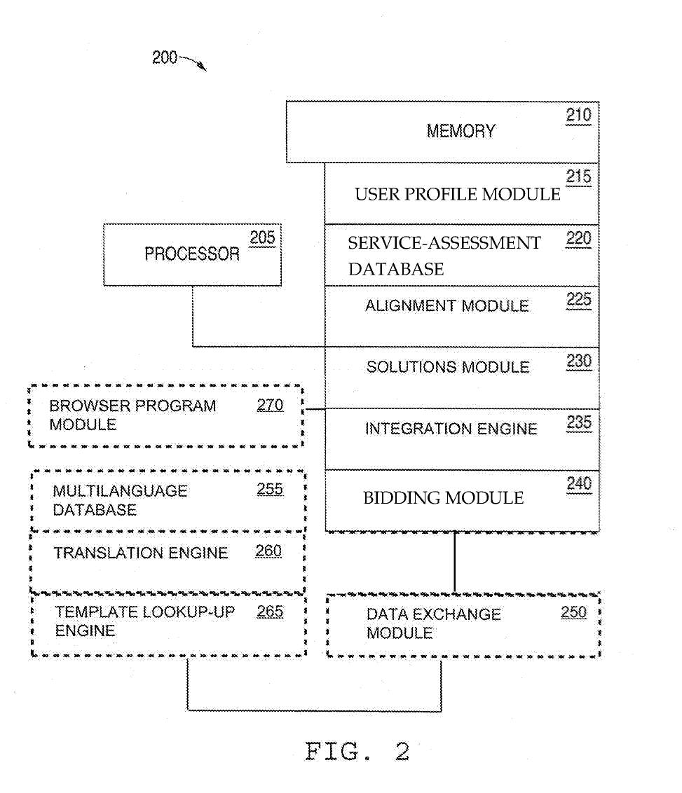

FIG. 2 illustrates a processor-memory diagram to describe components of the professionally-qualified bidding system, according to some embodiments. The system 200 shown in FIG. 2 contains a processor 205 and a memory 210 (that can include non-volatile memory), wherein the memory 210 includes a user-profile module 215, a service-assessment database 220, an alignment module 225, a solutions module 230, an integration engine 235, and a bidding module 240.

The system can include an input device (not shown) operable to allow a user or service provider a way to enter into, or access information from, the system. In some embodiments, the input device can be operable for accepting user-oriented data. The user-oriented data can include (i) a personalized user-profile and (ii) a professional-qualifier to qualify a user's request for a professional service from a service provider. The user-oriented data can include information from answers to a template questionnaire from the user or provider, and an identification of the professional service sought by the user. In some embodiments, the user-oriented data can comprise one or more of the subject's age, sex, height, weight, known medical conditions, vital signs, test results, prior conditions, prior treatments, lifestyle habits (smoking, alcohol), current and past medications, prescriptions, and family medical history. Likewise, in some embodiments, the system can comprise a data exchange module embodied in a non-transitory computer readable storage medium for interacting with external medical data formats, wherein the user-oriented data can comprise external medical data obtained from a health provider's database. And, in some embodiments, the system can further comprise an external computer connection and a browser program module embodied in a non-transitory computer readable storage medium, wherein the browser program module accesses external data through the external computer connection to update the service-assessment database.

In some embodiments, the user-profile module 215 can be embodied in a non-transitory computer readable storage medium for receiving the user-oriented data. In some embodiments, the system can provide a set of data entry forms, surveys, screens and tools from which the system can receive information from users. The data can include, for example, information on the recipient of the professional services. In the area of professional healthcare, the data may include one or more of the age, sex, height, weight, known medical conditions, vital signs, laboratory test results, prior conditions, prior treatments, lifestyle habits (smoking, alcohol), current and past medications, prescriptions, and family medical history.

In some embodiments, the system can access any of a variety of accessible data through an optional data exchange module, as discussed above. Likewise, the service-assessment database 220 can be embodied in a non-transitory computer readable storage medium and comprise a library of service-related information containing information relevant to the professional service requested by the user.

In some embodiments, the alignment module 225 can be embodied in a non-transitory computer readable storage medium for aligning the user-oriented data with professional-oriented data and the service-related information from the service-assessment database 220. Likewise, the solutions module 230 can be embodied in a non-transitory computer readable storage medium for parsing the service-related information into information subsets that include a risk subset for establishing a risk, complication and ease measurement of the service sought by the user.

In some embodiments, the integration engine 235 can be embodied in a non-transitory computer readable storage medium for (i) integrating information between the information subsets; (ii) identifying any conflicting information; and (iii) compiling data comprising the integrated information and any conflicting information into an assessment format for the user. The assessment format can include, for example, information designed to assist the user in understanding a response from a service provider. Moreover, in some embodiments, the assessment format can include a service appraisal checklist for use by either the professional service provider, the user, or both. In these embodiments the checklist can be technically detailed for the service provider and summarized in layman's terms for the user to help address and/or solve the problem of communications between the professional and the layman.

The solution's module 230 can be operable to parse the relevant information in the service-assessment database 220 into information subsets. And, the integration engine 235 can be operable to integrate the user-profile with relevant information. In some embodiments, the relevant information can include health information, and the system can identify conflicting health information, contraindications, or health warnings obtained from the service-assessment database 220. The system can then notify the user and/or service provider about the conflicting health information, contraindications, or health warnings obtained from the service-assessment database 220. The data can be compiled for presentation to the user and/or service provider in either a default or custom format selected by the user and/or provider. The bidding module 240 can be embodied in a non-transitory computer readable storage medium for converting the compiled data into a bidding format for use by the user. In some embodiments, the bidding format can include the service requested and the risk measurement for the service requested. And, in some embodiments, the user-oriented data can include a time limit for the service provider to respond to the user. A graphical user interface (not shown) can be used to display data from the system to the user or the service provider.

As described herein, in some embodiments, the system can further comprise a data exchange module 250 operable to interact with external data formats. For example, the user-profile can comprise external medical data obtained from a health provider's database. In some embodiments, the data exchange module includes an ePHR data exchange module. This module allows the system to interact with external ePHR/EMRs using standard medical data formats such as Continuity of Care Record (CCR) and Continuity of Care Document (CCD) data. In addition, the system will allow data exchange using a proprietary SOAP based API enabling integration with future technologies based on the SOAP/XML protocols.

In some embodiments, the system further comprises a multilanguage database 255, a translation engine 260, and a template look-up engine 265. The multilanguage database 255 includes a plurality of phrase templates associated with a plurality of phrases in the recognized health profile and the library of health information, the translation engine 260 is operable to translate the relevant phrase template from a source language to a destination language selected from multiple languages in the multilanguage database 255, and the template look-up engine 265 is operable to find the phrase template associated with the destination phrase from among the multiple languages.

In some embodiments, the system further comprises a messaging module (not shown) operable to allow users to communicate with other users having like subject-profiles, or others users in a profile independent manner, merely upon election of the user. Moreover, in some embodiments, different types of users such as providers and service-recipients can communicate with each other under certain time, user-defined or system-defined constraints in by way of a system-controlled modality that adheres to HIPAA-compliant communication protocols known to those skilled in the art. The users can email one another, post blogs, or have instant messaging capability for real-time communications. In some embodiments, the users have video and audio capability in the communications, wherein the system implements data streaming methods known to those of skill in the art.

The system can send alerts to patients when a doctor makes a bid on a procedure, changes the procedure or a change is made to the preset appointment time of the procedure. Furthermore, the system can send alerts when the system rejects a patient's request for acceptance into the system, a real-time agreement on price and conditions of a service is agreed upon or a request for communication or more information by one or more parties is made. Alerts can be pushed to any mobile device such that the patient receives the text message in real time either through traditional SMS/MMS or other proprietary application-based messaging system that runs through the mobile devices OS. An example of an alert would be an appointment reminder sent to the mobile device as described in the pathways in the figures. It should be appreciated that this can be done using the real-time or near real-time functionality of the system.

The systems taught herein can be practiced with a variety of system configurations, including personal computers, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network. As such, in some embodiments, the system further comprises an external computer connection and a browser program module 270. The browser program module 270 is operable to access external data through the external computer connection to update the service assessment database 220.

The system can have the capability of optimizing information as it learns, to create an optimized qualification for the service requested by the user. In some embodiments, wherein the professional-qualifier is second professional-qualifier optimized from a first professional-qualifier by the user interactively answering additional queries generated by the system and derived at least in part from the user-profile. As such, the professional-qualifier can be from an actual professional that has provided qualifying information, from a user answering questions from the system, or a combination thereof. The system can provide the service provider with an opportunity to make additional queries or request that the system do so, for example, before making an offer or counter offer. In these embodiments, the second professional-qualifier can be further optimized by the user interactively answering one or more additional queries generated by the system, and the user-profile, wherein the professional qualifier is iteratively optimized at each level of questioning to any number of iterations. It should also be appreciated that in some embodiments, multiple professional providers are involved and can make a joint decision in a single professional request if the expertise of more than professional is required and co-dependent to provide the service.

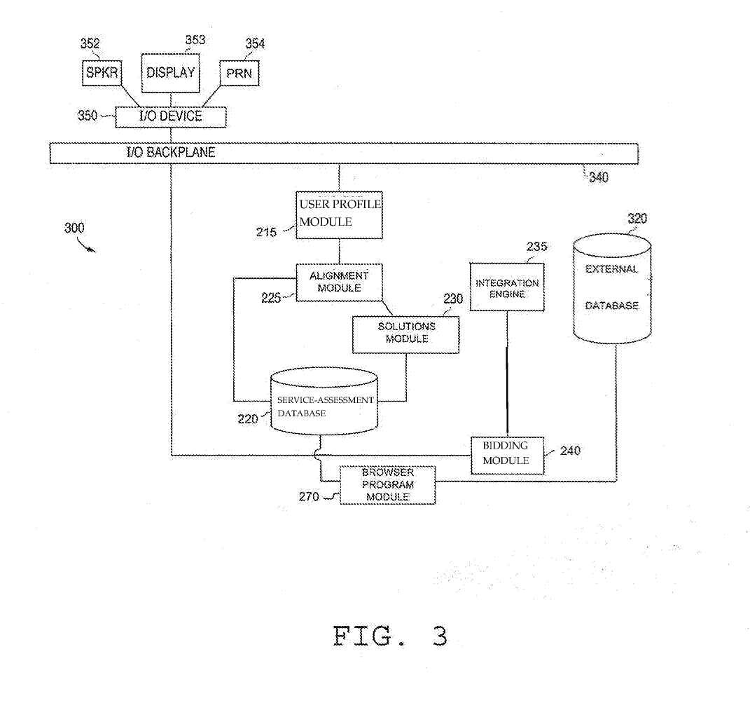

FIG. 3 is a concept diagram illustrating the professionally-qualified bidding system, according to some embodiments. The system 300 contains components that can be used in a typical embodiment. In addition to the user-profile module 215, service-assessment database 220, the alignment module 225, the solutions module 230, the integration engine 235, and the bidding module 240 shown in FIG. 2, the memory 210 of the device 300 also includes the browser program module 270 for accessing the external database 320. The system includes a speaker 352, display 353, and a printer 354 connected directly or through I/O device 350 connected to I/O backplane 340.

The system can be implemented in a stand-alone device, rather than a computer system or network. In figure FIG. 3, for example, the I/O device 350 connects to the speaker (spkr) 352, display 353, and microphone (mic) 354, but could also be coupled to other features. In a device offering language translation, the device can have a source language state selector and a destination language state selector connected directly to the I/O backplane 340. In many embodiments, the system can also a mute/volume state selector connected directly to the I/O backplane 340. Other features can be added such as, for example, an on/off button, a start button, an ear phone input, and the like. In some embodiments, the system can turn on and off through motion. In some embodiments, the system can have a state selector to select a preprogrammed voice that is pleasing to the user.

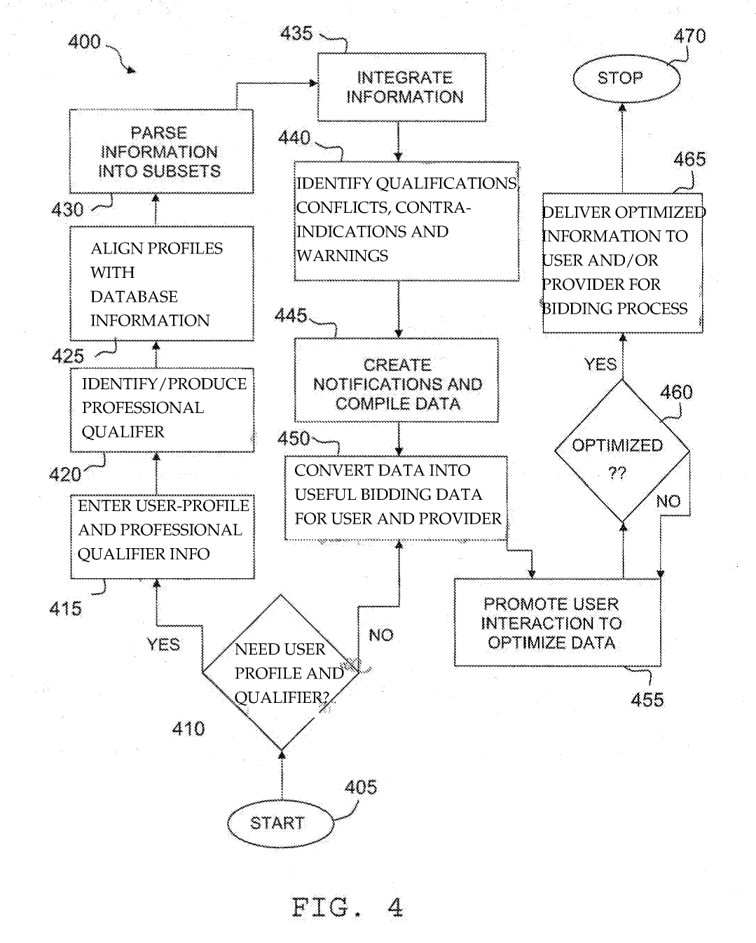

FIG. 4 is a diagram of the logic of the system for the professionally-qualified bidding system, according to some embodiments. In such embodiments, the system will start 405 by determining whether the system needs a user-profile for that task. If the answer is no, the system has recognized that the required user-profile has been entered and will access and convert data as needed for the present task. Of course, the user can have the opportunity to re-enter and/or update the information. In some embodiments, the updates include electronically accessed information from, for example, health care professionals, that can provide qualifying information for the service requested by the user. If the answer is yes, the system will prompt the user to enter 415 a personalized, user profile. The system will then produce 420 a professional-qualifier profile using information from the user-profile module and align 425 the professional-qualifier profile with the health information database information using the alignment module. The system will then parse 430 the information into subsets using the solutions module, and integrate 435 the information using the integration engine. The integration engine will identify 440 conflicts, contraindications, and warnings, create 445 notifications about the conflicts, contraindications, and health warnings, and compile data. The system then converts 450 the data into data useful to the service provider for bidding through the bidding module.

A plan conflict can arise, for example, where a user and/or service provider receives conflicting information in response to a user-profile. In some embodiments, the system accesses information from the service-assessment database, which can access the information entirely within the existing database or from external sources, and such information can be conflicting. In these embodiments, for example, the subject may be asked for more information to clear, confirm, or qualify the conflict or apparent conflict.

In some embodiments, a contraindication can arise. In health services, for example, a condition can make a particular treatment or procedure inadvisable. In some embodiments, one condition may call for the administration of one or more types of drugs. A contraindication may arise where another condition prohibits the use of one or more of those drugs. One of skill will appreciate that contraindications may be absolute or relative. An absolute contraindication is a situation which makes a particular treatment or procedure absolutely inadvisable. In a baby, for example, aspirin may be absolutely contraindicated because of the danger that aspirin will cause Reye syndrome. A relative contraindication is a condition which makes a particular treatment or procedure somewhat inadvisable but does not rule it out. For example, X-rays in pregnancy are relatively contraindicated because of concern for the developing fetus, unless the X-rays are absolutely necessary. Those skilled in the art will often take x-rays when necessary and some times double lead-apron the pregnant patient. Work-arounds for relative contraindications can be presented to the patient as well at step 460-465 in order for the patient to assess whether he/she would like to proceed with the bidding module for the treatment given possible risks and necessary work-arounds. A health warning can arise, for example, where the system makes reference to an official declaration that a particular substance or activity in the user-profile is dangerous, and can also arise where information otherwise relevant to the user-profile is obtained, where that information is considered sufficiently relevant to justify the health warning. Information becomes sufficiently relevant where the general health community would feel that it is reasonable to advise the subject to consult with a health professional. One of skill will also appreciate that conflicts, contraindications, and warnings can arise in a multitude of circumstances that are much too numerous to list in this teachings and, thus, much too numerous for any one professional to amass as part of a single professional practice. Thus, such information represents information that would be highly desired by the users and service providers.

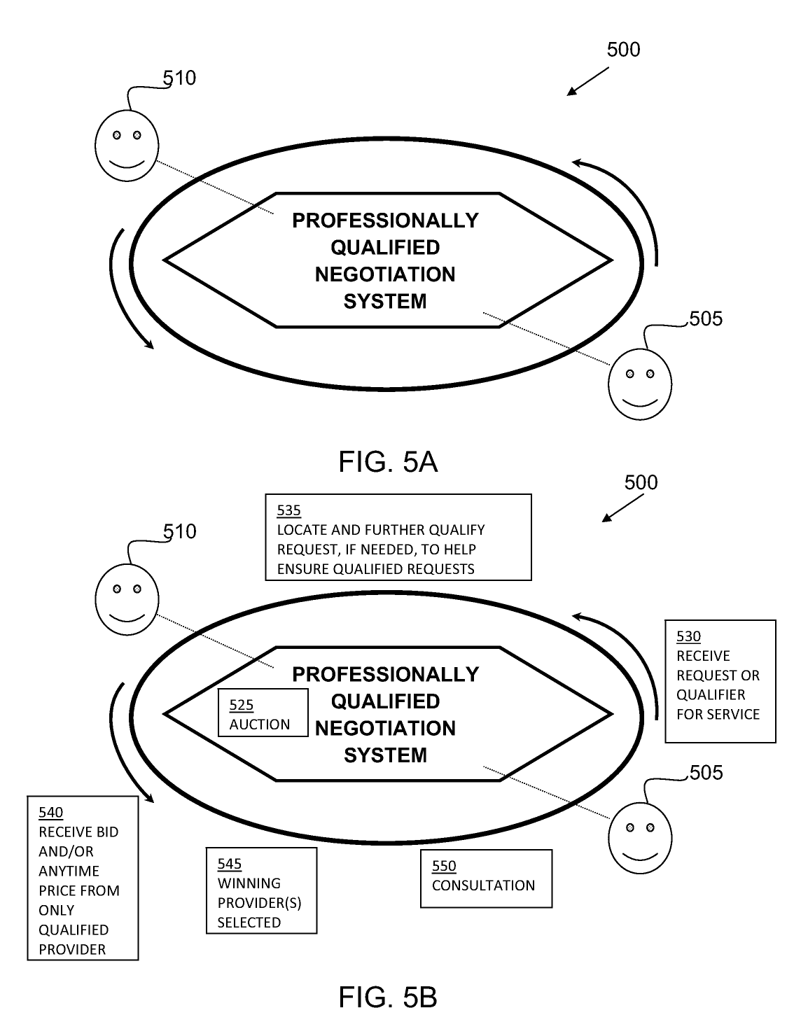

FIGS. 5A and 5B illustrate the basic concept of the system in the healthcare industry, according to some embodiments. In FIG. 5A, the system 500 illustrates the simplicity of the relationship between patients 505 seeking professional healthcare services and providers 510 of such services. Patients 505 request 515 that providers 510 bid for procedures, such as elective procedures, that they wish to have done. Providers 510 review 520 applicable procedures and state the price at which they would be willing to perform the procedure. In FIG. 5B, the system 500 performs a healthcare auction 525 in the negotiation between the patients and service providers. Initially, the system 500 receives 530 a patient (or case worker, for example) request for free or reduced-cost health care services. The system 500 locates 535 the patient request and, further qualifies if lacking in qualification, to help ensure the request is qualified for the provider.

The request for a service can be entered using any of a variety of forms of information that can qualify a user's request for a service. In some embodiments, the system 500, can receive 530 a manual input of the treatment previously diagnosed for the patient by a health professional or it can receive 530 a printout of a treatment plan, for example, and have it scanned via OCR or uploaded via mobile device or other capture method. In these embodiments, the OCR can detect and capture the information into a computing data structure, the date of the treatment plan, the procedure type, quantity and an estimated total amount or range that may be expected for each procedure in the treatment plan. The preceding parameters can be parsed via OCR and inputted in the system's database for use in data capture, analysis, and serve as a basis for the patient's expectation of the price negotiation. The price is not displayed to potential health providers who are the bidders on the System in order to prevent price fixing or bias.

In one embodiment, the patient's (e.g., the user's) request is received 530 with a description of the symptoms and/or a requested specialist. The patient can request all or a portion of a wide variety of data regarding a provider. In some embodiments, a patient can request a desired (i) location of the provider; (ii) specialty; and, (iv) experience of the provider (an average number of procedures performed by each listed provider, for example, can be shown). In some embodiments, a user can also request a list of international or domestic providers. In some embodiments, the educational and training background of the provider, as well as a ranking range of the provider by the professional and patient community, can be included.

The system can include search technology for negotiating services. In one embodiment, the technology includes a system for parsing specialists and the respective procedures performed in the healthcare industry. This allows patients to find out which specialists most often perform what type of procedure and to allow the patient to view specialist types based off of region. For example, a patient in the U.K. may have a different name for the same type of specialist in the U.S. Therefore, when a patient searches for a specialist, the method for search is to take the location parameter or other identifying location parameter such as the location detected via IP address header (geolocation) or the user's profile settings.

The performance of professional services can sometimes require that information about the user or service remain confidential. In such embodiments, there can be security measures to protect the subject's privacy, integrity of data, or both. In some service industries, the privacy of the user requesting services must be protected. The healthcare industry must follow the Health Insurance Portability and Accountability Act (HIPAA). In the system 500, the patient's identity and personal information can be blocked to preserve privacy, while other indications (e.g. age, gender, symptoms) may be revealed to a health provider with sufficient security credentials to view sensitive patient data. Test information, such as x-rays, laboratory, and other diagnostic information can optionally be uploaded by the patient to include full details of the clinical case to potential health providers. A health provider or a volunteer health provider, such as a specialist, or organization can use the system to locate and access a patient request through, for example, a keyword search or other health condition identifying criteria.

The system then receives 540 a bid (and/or an anytime price). The bid can come, for example, from one or more volunteer or paid health practitioner for a predetermined time period (e.g. an auction lasting for a predetermined amount of time, number of received bids, bids reading $0, acceptance by the patient). The patient then reviews the received bids and a winning provider is selected 545. Selection 545 may be accomplished by choosing the lowest bid during the auction period, or may be indicated by the patient (e.g. the patient selects 545 a “winning bid” before the auction time expires). Once the auction is ended, the system 500 sends a secure message to one of (or both) the patient and the health provider so they can arrange for a consultation 550 regarding the services. In some embodiments, the health practitioner can make a bid contingent on a specific scheduled day/time, range of days/times, or make the offer based off of contingencies in price, time or other information.

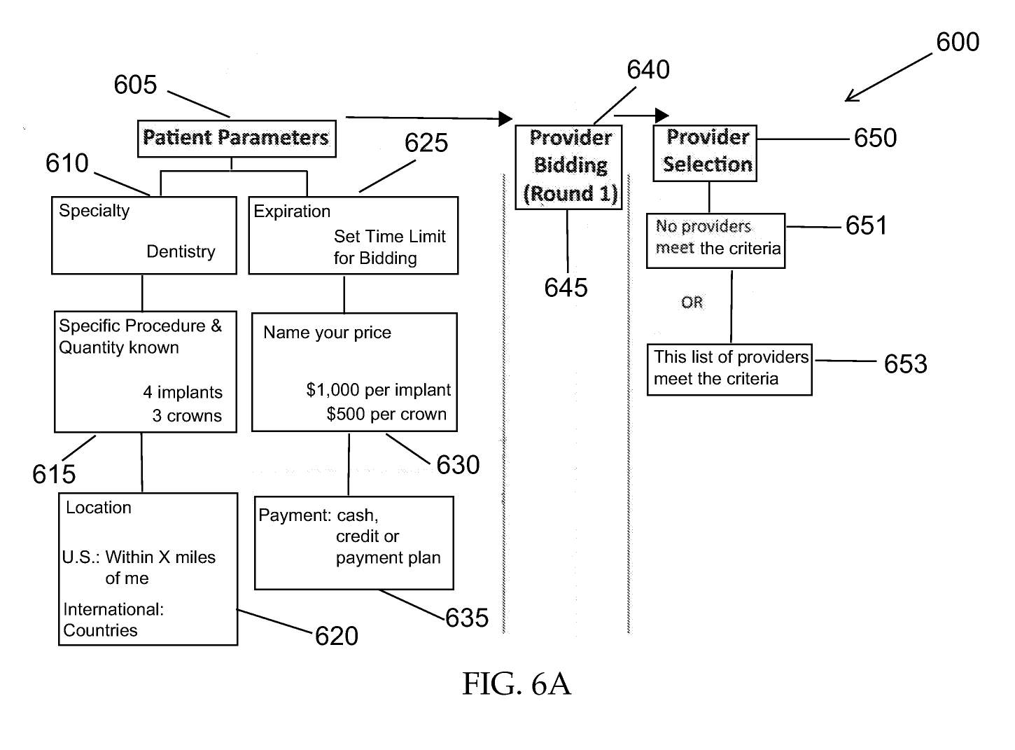

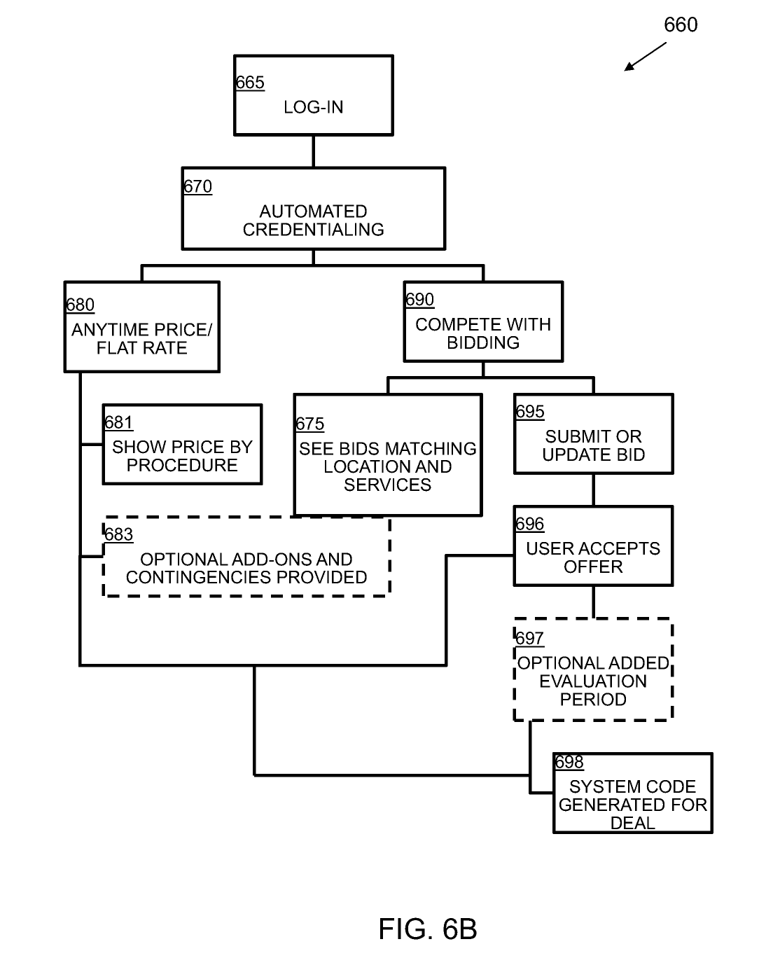

FIGS. 6A and 6B illustrate provider and patient pathways through the system, according to some embodiments. FIG. 6A illustrates a patient pathway 600 in which a patient (e.g., user) can select patient parameters 605. The patient parameters 605 can include, for example, a desired specialty 610, specific procedure and quantity 615, desired location for procedure 620, and an expiration 625 time limit for the bidding. In some embodiments, the patient pathway 600 can include an option for a patient to set a maximum price 630 for bids and methods of payment 635. Provider bidding 640 can occur in one or more rounds 645, in which provider selection 650 is the end result. The system patient pathway 600 can return results from each round 645, for example, indicating that (i) no providers 651 meet the criteria or (ii) the following list of providers 653 meet the criteria for selection.

FIG. 6B illustrates a provider pathway 660 in which a service provider can select provider parameters that include log-in 665 and credentialing 670. Providers can elect to see bids within particular matching limitations 675, such as zip code and specialty area of procedures performed by the provider. The provider pathway 660 can include other options, such as an “any-time price” 680 (i.e., automatic selling price, “I will do it at this price any time”) with which a provider can specify their lowest price per procedure 681 and optional add-ons 683 that may be incurred at the time of service, a contingency to their lowest price, based on scheduled time, additional procedures, and other criteria not assessable through the professional-qualification system. In some embodiments, the provider may set multiple any-time prices dependent on specific dates/times or range of times that the patient is willing to come in for the treatment. For example, a provider may decide to offer a lower price during slower times and offer a higher price during busy times (holidays, when school is out of session, etc.) The provider pathway 660 also includes the option to compete 690 with other providers and bid on the patient's requested procedure. After selecting the desired provider pathway 660, the provider can submit 695 the pathway to the system. At which time, the offer can be accepted by the user 696. In some embodiments, the bidding process can include an additional evaluation/selection step 697 in which the patient and provider can ask each other specific questions through an optional evaluation step, or sometimes an extended-evaluation step, and an optional video conference, teleconference written exchange, and/or in person meeting with office staff or the health provider can also be available. The systems taught herein can be designed to facilitate this optional extra step.

In some embodiments, after a successful bidding session in which the patient (e.g., user) selects at least one service provider, a secret random key is generated 698 as, for example, an alphanumeric code 6X343F45D97 to represent the deal and potentially serve as a deal-access code. The code can be sent, for example, by email to both the winning provider or providers, or the otherwise chosen provider. The patient (e.g., user) also receives the code for verification. This alphanumeric code can be correlated against the system's database to retrieve the negotiated the “meeting of the minds” which may include, in some embodiments, purchase price, name/address of provider and patient, patient's health history, any contingencies on the procedure delivery (such as health conditions, co-morbidities, extra $ charges that may be possible and only known just before the procedure or after a consult). In some embodiments, an optional barcode can be attached to a printable voucher that the patient can use at the health provider's office. It should be appreciated that this voucher can also be designed to meet HIPAA requirements. In some embodiments, this voucher would not contain the patient's name or health history but would contain the parameters listed above in order to maintain HIPAA privacy.

The practitioner can set their “anytime price,” a price for a specific health procedure code is offered at a specific price, and offer a limited or an unlimited amount of the procedures at the anytime price. Whenever a patient chooses to accept the specified price, an electronic link can be created whereby an alphanumeric code is sent to both parties. This code can allow for access to the accepted treatment, price, date of negotiation, and other pertinent parameters of a health service delivery.

The existence of a qualified request accompanied by a professional qualifier can be very valuable to the service provider. In some embodiments, the practitioner can bid on a single procedure, or a group of procedures, based on the professional-qualifier providing codes and options that the service provider understands. In the healthcare industry, for example, the patient could upload a quote or diagnosis from another practitioner, inputting this information into the patient's online account. Providers can then provide a bid on the total package of codes and their respective quantities, along with certain contingencies that would substantiate additional charges if needed or desired. The practitioners, for example, can have access to specific CDT/CPT/HCPCS/ICD-9-CM/ICD-10-CM/DRG codes (dental and medical codes).

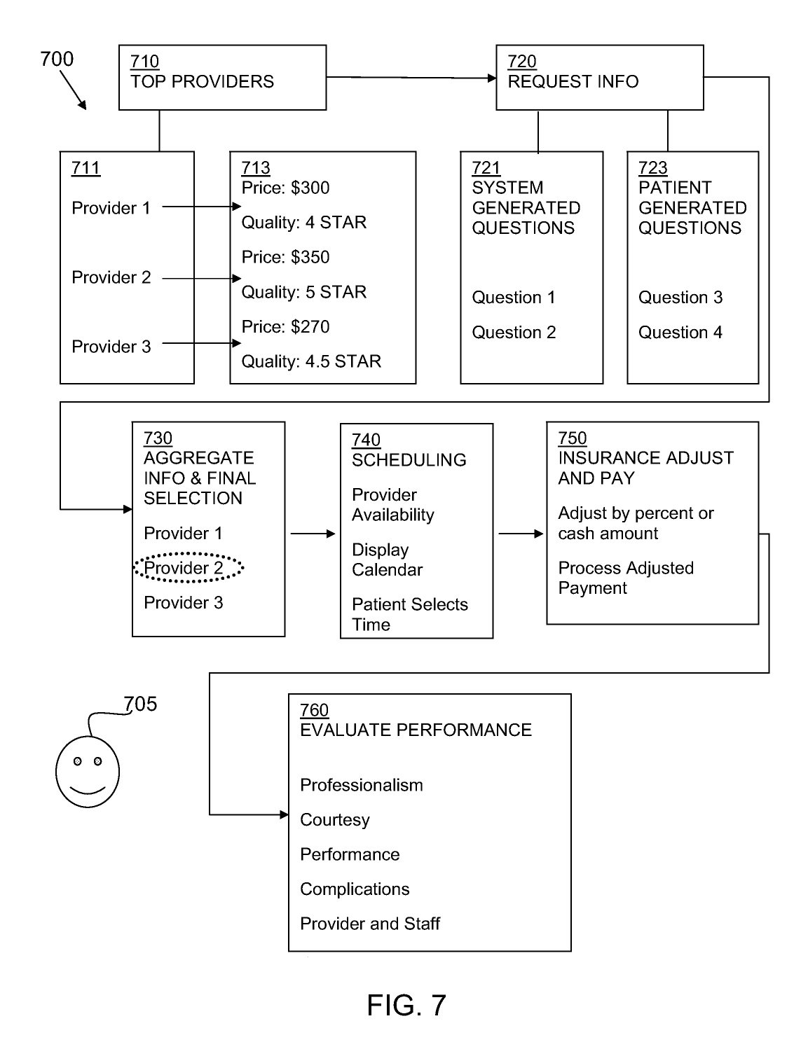

FIG. 7 illustrates a transaction pathway between a user and service provider in the healthcare industry, according to some embodiments. The transaction pathway 700 starts with a patient 705 (e.g., user) creating a shortlist 710 of preferred providers, in which the short list shows the names 711 and professional comparison criteria 713 for the preferred providers. The patient can optionally request additional information 720 from the preferred providers to aid in the selection process, wherein the information requested can be from pre-populated questions 721 or patient-generated questions 723. The patient 705 can then aggregate all information 730 to make a final selection. The patient 705 can then optionally use the system for scheduling 740, apply insurance and pay 750, and later evaluate 760 the procedure performed using criteria that can include, for example, professionalism, courtesy, performance, complications, and the like.

In some embodiments, insurance adjustments can be made in the process of negotiating a price for a professional service such as, for example, a health care service. Insurance adjustments can be made to a procedure price when either: a) insurance will cover a portion of the total price of the health procedure by code up to a certain $ amount specified by a certain set of restrictions; or b) Insurance will cover a percentage of the total price of the health procedure by code up to a certain $ amount or up to a certain price for a health procedure (pre-defined fee schedule).

In some embodiments, a patient enters their insurance information into the system prior to requesting bids. The health insurance information can include the patient's name, billing group, member id, insurance plan, insurance verification web site. A method of auto-verification, such as described herein, could be used to verify and extract the patient's coverage for a specific set of health procedures against a database of covered procedures, codes or a provider fee schedule. A discount (coverage from insurance) would be processed and added to the updated patient's charges. Likewise the system can also the concept of group buying powers, in which a group of patients can get a reduce rate through an en masse decision to purchase the same procedure on the same or similar date or dates by the same group of health provider(s).

For example, a procedure fee can be negotiated at $400 for a root canal on #19, and the patient decides to use his insurance. The patient's insurance would be verified automatically by the system. If the coverage for this procedure is 75%, then a 75% “discount” would be applied at checkout and the patient would just be expected to pay $100 at time of service. This payment can be collected through a checkout/payment page or in person at the time the service is rendered. The health provider would not bill the procedure to the insurance company until after the service has actually been rendered so only $100 would be collected upfront from the patient while the $300 would come at a different time.

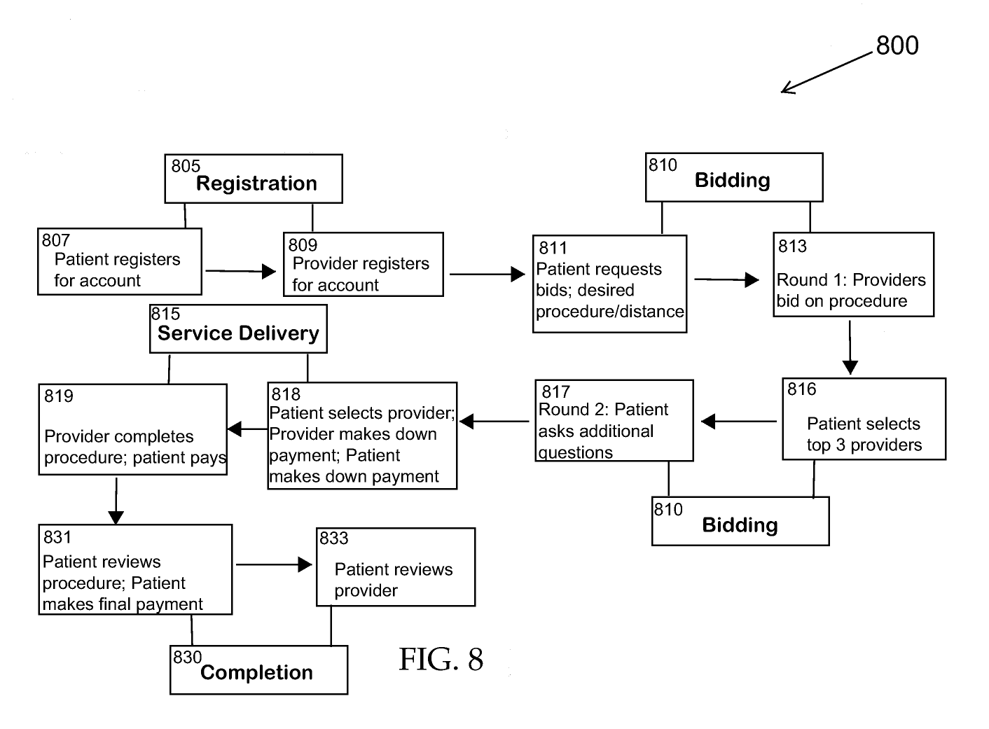

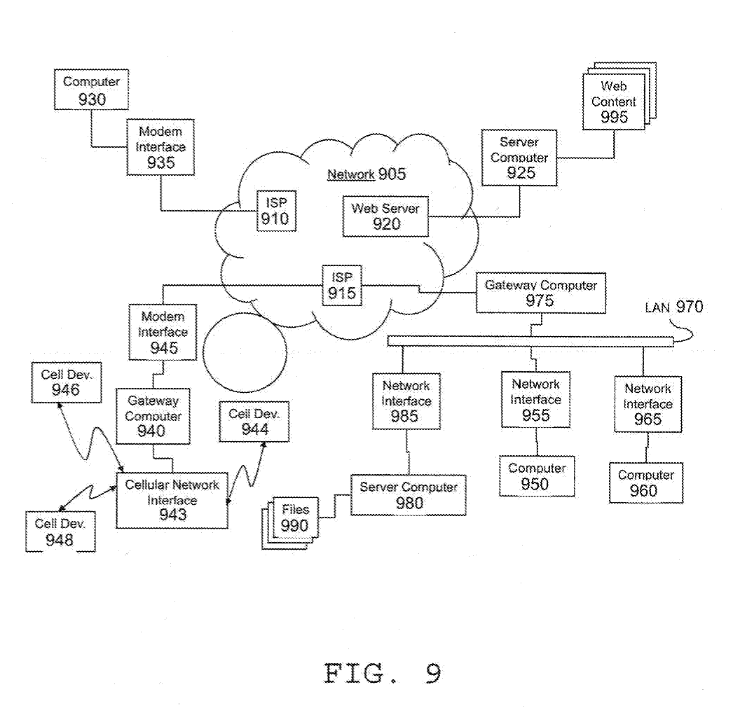

FIG. 8 illustrates an overview of the entire process as applied to the healthcare industry, according to some embodiments. The process 800 includes, but is not limited to, registration 805 by both the patient (e.g., user) 807 and provider 809; bidding 810 in which the patient requests 811 a bid and the provider provides 813 a bid in at least a single round; service delivery 815 in which the patient has selected a shortlist of top providers 816, has requested and received additional information 817 from the shortlist 816, makes a final selection 818 of a single provider, and the provider completes 819 the procedure; and completion 830, in which the patient pays 831 the provider and reviews 833 the provider performance 831 in the system.

From the standpoint of the professional service provider, the system can include any of the options available to the user as taught herein, however, the service provider can have other options that are not needed for use or viewing by the user. In one example, the assessment format can include information designed to assist the provider in forming an understandable response to the user. In another example, the professional-oriented data can include a flat rate for the service requested by the user. Of course, the user can accept the flat rate for any reason, where acceptance of the flat rate may be expected to expedite a performance of the service by the service provider. The service provider can also update an offer or counter offer, and the user can view the updated offer or counter. The user can receive a prompt from the system regarding such an update, and the prompt can be received “on-the-fly”, such that the update can be considered real-time, or near real-time.

It should be appreciated that a user can gain access to the system through any connection to the system. In some embodiments, the user is mobile, and the input device, the output device, or both, is provided through a portable, single unit device. And, in some embodiments, the device comprises a portable, single unit, handheld device. The handheld device can be, for example, a cell phone, smart phone, PDA, iPAD, laptop computer, and the like.

As described herein, the system can include privacy measures. In some embodiments, the system further comprises security measures to protect the subject's privacy, integrity of data, or both. Such security measures are those well-known in the art such as firewalls, software, and the like. In addition, the system can be configured for use in an environment that requires administrative procedures and control. For example, the system can include an administrative module operable to control access, configure the engines, monitor results, perform quality assurance tests, and define audiences for targeting and trending. Since the system can safely be provided by a network and, in some embodiments, the system is coupled to a network, the security measures can help protect the contents of the system from external intrusions.

In some embodiments, the system is a web enabled application and can use, for example, Hypertext Transfer Protocol (HTTP) and Hypertext Transfer Protocol over Secure Socket Layer (HTTPS). These protocols provide a rich experience for the end user by utilizing web 2.0 technologies, such as AJAX, Macromedia Flash, etc. In some embodiments, the system is compatible with Internet Browsers, such as Internet Explorer, Mozilla Firefox, Opera, Safari, etc. In some embodiments, the system is compatible with mobile devices having full HTTP/HTTPS support, such as iPhone, Android, PocketPCs, Microsoft Surface, Video Gaming Consoles, and the like. In some embodiments, the system can be accessed using a Wireless Application Protocol (WAP). This protocol will serve the non HTTP enabled mobile devices, such as Cell Phones, BlackBerries, etc., and provides a simple interface. Due to protocol limitations, the Flash animations are disabled and replaced with Text/Graphic menus. In some embodiments, the system can be accessed using a Simple Object Access Protocol (SOAP) and Extensible Markup Language (XML). By exposing the data via SOAP and XML, the system provides flexibility for third party and customized applications to query and interact with the system's core databases. For example, custom applications could be developed to run natively on iPhones, Java or .Net-enabled platforms, etc. One of skill will appreciate that the system is not limited to the platforms discussed above and will be amenable to new platforms as they develop.

FIG. 9 shows how a network may be used for the personalized health information discovery and presentation system in some embodiments. FIG. 9 shows several computer systems coupled together through a network 905, such as the internet, along with a cellular network and related cellular devices. The term “internet” as used herein refers to a network of networks which uses certain protocols, such as the TCP/IP protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 905 is typically provided by internet service providers (ISP), such as the ISPs 910 and 915. Users on client systems, such as client computer systems 930, 950, and 960 obtain access to the internet through the internet service providers, such as ISPs 910 and 915. Access to the internet allows users of the client computer systems to exchange information, receive and send e-mails, and view documents, such as documents which have been prepared in the HTML format. These documents are often provided by web servers, such as web server 920 which is considered to be “on” the internet. Often these web servers are provided by the ISPs, such as ISP 910, although a computer system can be set up and connected to the internet without that system also being an ISP.

The web server 920 is typically at least one computer system which operates as a server computer system and is configured to operate with the protocols of the world wide web and is coupled to the internet. Optionally, the web server 920 can be part of an ISP which provides access to the internet for client systems. The web server 920 is shown coupled to the server computer system 925 which itself is coupled to web content 995, which can be considered a form of a media database. While two computer systems 920 and 925 are shown in FIG. 9, the web server system 920 and the server computer system 925 can be one computer system having different software components providing the web server functionality and the server functionality provided by the server computer system 925 which will be described further below.

Cellular network interface 943 provides an interface between a cellular network and corresponding cellular devices 944, 946 and 948 on one side, and network 905 on the other side. Thus cellular devices 944, 946 and 948, which may be personal devices including cellular telephones, two-way pagers, personal digital assistants or other similar devices, may connect with network 905 and exchange information such as email, content, or HTTP-formatted data, for example. Cellular network interface 943 is coupled to computer 940, which communicates with network 905 through modem interface 945. Computer 940 may be a personal computer, server computer or the like, and serves as a gateway. Thus, computer 940 may be similar to client computers 950 and 960 or to gateway computer 975, for example. Software or content may then be uploaded or downloaded through the connection provided by interface 943, computer 940 and modem 945.

Client computer systems 930, 950, and 960 can each, with the appropriate web browsing software, view HTML pages provided by the web server 920. The ISP 910 provides internet connectivity to the client computer system 930 through the modem interface 935 which can be considered part of the client computer system 930. The client computer system can be a personal computer system, a network computer, a web TV system, or other such computer system.

Similarly, the ISP 915 provides internet connectivity for client systems 950 and 960, although as shown in FIG. 9, the connections are not the same as for more directly connected computer systems. Client computer systems 950 and 960 are part of a LAN coupled through a gateway computer 975. While FIG. 9 shows the interfaces 935 and 945 as generically as a “modem,” each of these interfaces can be an analog modem, isdn modem, cable modem, satellite transmission interface (e.g. “direct PC”), or other interfaces for coupling a computer system to other computer systems.

Client computer systems 950 and 960 are coupled to a LAN 970 through network interfaces 955 and 965, which can be ethernet network or other network interfaces. The LAN 970 is also coupled to a gateway computer system 975 which can provide firewall and other internet related services for the local area network. This gateway computer system 975 is coupled to the ISP 915 to provide internet connectivity to the client computer systems 950 and 960. The gateway computer system 975 can be a conventional server computer system. Also, the web server system 920 can be a conventional server computer system.

Alternatively, a server computer system 980 can be directly coupled to the LAN 970 through a network interface 985 to provide files 990 and other services to the clients 950, 960, without the need to connect to the internet through the gateway system 975.

Through the use of such a network, for example, the system can also provide an element of social networking, whereby users can contact other users having similar subject-profiles, or user can contact loved ones to forward the personalized information. In some embodiments, the system can include a messaging module operable to deliver notifications via email, SMS, and other mediums. In some embodiments, the system is accessible through a portable, single unit device and, in some embodiments, the input device, the graphical user interface, or both, is provided through a portable, single unit device. In some embodiments, the portable, single unit device is a hand-held device. As such, it can be appreciated that all social networks currently available over the internet, for example, can be used in conjuction with, coupled to, or otherwise operably integrated with, the systems taught herein. Such systems can include for example FACEBOOK, LINKED-IN, and TWITTER.

The system has several ancillary benefits that provide their own, separate and valuable utility. For example, with the introduction of Health 2.0 and medical mobile technology, there has been a huge push to increasing efficiency in the medical and dental services sector. Primarily in emergency rooms, primary care clinics, dental clinics, hospitals and other high volume and consultation based health providers there has been an increased need for expediting a patient's experience in the doctor's office. With the introduction of the Centers for Medicare EHR “Meaningful Use” Standards, a standardized set of electronic health records made available in July, 2010, companies will now be forced to use a common set of parameters to store and transmit health records. This will allow more inter-usage of patient data and records between providers, which will further allow for inter-operability of health records and automation of services and procedures.

The system taught herein, can provide a conduit for procedural automation of various types of health record data, accessible from anywhere in the world, using any connection to the network, even a real-time or near real-time connection, and even a mobile connection. In some embodiments, as you input certain medical data such as a “high blood pressure” reading into your account, the system can automatically schedule an appointment with your primary care physician via a push notification to your doctor and an automated message to your doctor that you need an appointment. In addition, the system can also directly schedule an appointment based off of appointments already placed as “open” by the health provider on their public Internet-based system. In some embodiments, a sensor placed on the body, in a shoe sole or in a cellphone could detect smoke from cigarettes or that you are smoking cigarettes and if detected it would automatically push a notification to your physician signaling you inability to adhere to tobacco cessation plan instrumented by you and your health provider. In some embodiments, the system can monitor your purchase history based off of credit card and debit card. This information could serve as a source of information for your healthcare service provider, showing perhaps that you eat a lot of fast food or make purchases at a smoke shop, etc. This could result in a push notification to your primary care doctor that you need an appointment due to breaking of a request not to eat junk foods or smoke cigarettes due to a variety of health reasons from having a diagnosis of emphysema to diabetes type II, etc. It should be appreciated that these types of notifications could be linked to the system described herein to automatically schedule an appointment but based off of certain clinical criteria at a negotiated price based off the anytime price method described earlier.

Similarly, GPS services such as Google's latitude, longitude map services, FourSquare or Facebook's Places service could automatically detect what locations and restaurants you eat at in real-time and provide data repository to generate a report that can be sent to your doctor. For example, 20 restaurants (including McDonalds, Burger King, KFC) could be tracked over a daily period, and if your visits to any of these restaurants occurs, or if you reach a certain threshold of visits, an automatic message to a physician could occur. If this was coupled with the system, which would input the situation above and output the procedure required by the patient, then the physician who meets your price requirements would be selected based off certain criteria such as location proximity or education/training for example. And, this information, if permitted by the patient, could be used to provide another source of such nationwide data, and perhaps worldwide data, as another source of research data.

Some patients (e.g., users) could benefit tremendously from a safety point of view, if their physical condition could be monitored through the internet, for example. A mobile phone technology via mobile application could be enabled to monitor and detect the number of apneic events of a sleep apnea patient, for example, using any of a variety of technologies such as SaO2, digitized audio signal processing, leg movements, body movements and the like. The information exchange could be enabled via Bluetooth or other connectivity method to a mobile application which listens for and records the parameters over a specified time period. If certain conditions were met clinically, a certain procedure would be required and a patient could have their procedure price negotiated automatically using the system.

Push-messaging notifications could also go to your doctor based off of various clinical parameters such as your insulin level. Your doctor could set threshold values in your online profile during your previous doctor's visit and update parameters on a patient to look for certain events, such as if the blood pressure goes up. For example, the plan may be to determine if the blood pressure increases to 140/90, at which time the doctor would up the dosage of LISINOPRIL to perhaps 5 mg, and if blood pressure on a patient goes to 150/100, up the dosage of LISINOPRIL to 10 mg. Certain centers could be installed (such as pharmacies, retail medical centers, QuickHealth areas) which would allows users to check their vitals and other quantifiable parameters such that doctors could automatically respond with adjustments in dosages, etc. These type of services, which comprise concierge medicine monitoring services, would also be possible procedures which could be negotiated using this system. Moreover, this could be automated to the extent that the doctor could trigger an automated prescription to be written, sent via VoIP to a pharmacy.

In another example, a patient could enter their Epworth Sleepiness Scale information into their mobile device and the results could be transferred to the doctor. A push-message notification would be sent to the doctor if the range became, for example, between 10-24. The doctor could request a consult, or an automated medication adjustment could be made as described herein.

The system can be used in several ways as an additional application that links to a social network. A connection to, and between, social networks allows people to post non-confidential health updates such as “lost 30 lbs in the last 20 days!”, or “Got my teeth whitening for $50 at Dr. Jones office” At a patient's discretion, confidential health updates can also be posted onto social network systems. Moreover, this type of interaction can be exported to Facebook, or other social networks, for simple networking or online competitions.

Access to insurance information can be very helpful in the healthcare industry, for example. The system can also allow for health insurance information to be made portable in real-time. Insurance information such as provider number, plan name, plan id, group number, name on the card, subscription id, policy id, insurance phone, coverage start date, coverage end date, deductible, cost for office visit, fee schedules, co-pays, rx costs at up to three different tiers can be encoded into the database. The health care insurance information can be placed into the patient user's account and pulled up real-time via a bar-code technology or alphanumeric code, such as through a scanning or inputting the code at the doctor's office. Moreover, the insurance information can be emailed to the doctor in real-time or a photo can be sent via MMS, secure-system email to the doctor's office if it is stored on the patient's profile. In such embodiments, the need for a copy of the health insurance card can become obsolete.

The system can also allow patient to auto-generate a patient medical history in real-time from data located in their account in the systems taught herein. A list of the patient's medical conditions can be based on explicit health conditions saved in the patient's profile or, in some cases, conditions can be extrapolated as “virtual diagnoses” using standard measures that have not yet been correlated by a doctor. This health history can also be securely emailed, MMS sent, displayed on a mobile screen, or connected via USB, Bluetooth, etc. to quickly print from an attached computer when the patient enters a health provider's clinic. Moreover, the system can also serve as another safety measure that helps mitigate risk to the patient, as well as the doctor. For example, the system can also check for drug interactions as new drugs are placed into the patient's online repository.

We claim:

1. A professionally-qualified bidding system for a user seeking professional services, the system comprising:
a processor;
an input device operable for accepting user-oriented data including (i) a personalized user-profile and (ii) a professional-qualifier to qualify a user's request for a professional service from a service provider, wherein the user-oriented data includes information from answers to a template questionnaire from the user, and an identification of the professional service sought by the user;
a user-profile module embodied in a non-transitory computer readable storage medium for receiving the user-oriented data;
a service-assessment database embodied in a non-transitory computer readable storage medium and comprising a library of service-related information containing information relevant to the professional service requested by the user;
an alignment module embodied in a non-transitory computer readable storage medium for aligning the user-oriented data with professional-oriented data and the service-related information from the service-assessment database;
a solutions module embodied in a non-transitory computer readable storage medium for parsing the service-related information into information subsets that include a risk subset for establishing a risk measurement of the service sought by the user;
an integration engine embodied in a non-transitory computer readable storage medium for (i) integrating information between the information subsets; (ii) identifying any conflicting information; and (iii) compiling data comprising the integrated information and any conflicting information into an assessment format for the user;
a bidding module embodied in a non-transitory computer readable storage medium for converting the compiled data into a bidding format for use by the user; and
an output device operable for displaying the service-related information to the user;
wherein,
the professional qualifier provides the professional with an available pre-screening data regarding the user's need for the service and the risk of performing the service.

2. The system of claim 1, wherein, the professional qualifier is from a third-party professional.

3. The system of claim 1, wherein the assessment format includes information designed to assist the user in understanding a response from a service provider.

4. The system of claim 1, wherein the assessment format includes a service appraisal checklist.

5. The system of claim 1, wherein the bidding format includes the service requested and the risk measurement for the service requested.

6. The system of claim 1, wherein the user-oriented data includes a time limit for the service provider to respond to the user.

7. The system of claim 1, wherein the professional service is a health service, and the professional qualifier is provided by a licensed healthcare professional.

8. The system of claim 7, wherein the user-oriented data comprises one or more of the subject's age, sex, height, weight, known medical conditions, vital signs, test results, prior conditions, prior treatments, lifestyle habits (smoking, alcohol), current and past medications, prescriptions, and family medical history.

9. The system of claim 7, wherein the system comprises a data exchange module embodied in a non-transitory computer readable storage medium for interacting with external medical data formats, wherein the user-oriented data comprises external medical data obtained from a health provider's database.

10. The system of claim 7 further comprising an external computer connection and a browser program module embodied in a non-transitory computer readable storage medium, wherein the browser program module accesses external data through the external computer connection to update the service-assessment database.

11. The system of claim 7 further comprising security measures to protect the subject's privacy, integrity of data, or both.

12. The system of claim 7, wherein the system is provided over a network.

13. The system of claim 7, wherein the system is coupled to a network.

14. The system of claim 7, wherein the user is a first individual requesting a professional service for a second individual, the user selected from the group consisting of a parent, guardian, professional service provider, or an insurance provider.

15. The system of claim 7, wherein the user indicates an absence of a professional qualifier; and, interactively and iteratively answers one or more additional queries generated by the system to develop a virtual, professional qualifier.

16. The system of claim 7, wherein the input device, the output device, or both, is provided through a portable, single unit device.

17. The system of claim 7, wherein the portable, single unit device is a handheld device.

18. A professionally-qualified bidding system for a professional seeking a user of professional services, the system comprising:
a processor;
an input device operable for accepting professional-oriented data including a professional-profile, wherein the professional-oriented data includes professional qualification information;
a professional-profile module embodied in a non-transitory computer readable storage medium for receiving the professional-oriented data;
a service-assessment database embodied in a non-transitory computer readable storage medium and comprising a library of service-related information containing information relevant to a professional service requested by a user;
an alignment module embodied in a non-transitory computer readable storage medium for aligning the user-oriented data with professional-oriented data and the service-related information from the service-assessment database;
a solutions module embodied in a non-transitory computer readable storage medium for parsing the service-related information into information subsets that include a risk subset for establishing a risk measurement of the service sought by the user;
an integration engine embodied in a non-transitory computer readable storage medium for (i) integrating information between the information subsets; (ii) identifying any conflicting information; and (iii) compiling data comprising the integrated information and any conflicting information into an assessment format for the service provider;
a bidding module embodied in a non-transitory computer readable storage medium for converting the compiled data into a bidding format for the service provider; and
an output device operable for displaying the service-related information to the service provider;
wherein,
the professional qualifier provides the professional with an available pre-screening data regarding the user's need for the service and the risk of performing the service.

19. The system of claim 18, wherein the professional qualifier is from a third-party professional.

20. The system of claim 18, wherein the assessment format includes information designed to assist the provider in forming an understandable response to the user.

21. The system of claim 18, wherein the assessment format includes a service appraisal checklist.

22. The system of claim 18, wherein the bidding format includes the service requested and the risk measurement for the service requested.

23. The system of claim 18, wherein the professional-oriented data includes a flat rate for the service requested by the user that can be accepted by the user to expedite a performance of the service by the service provider.

24. The system of claim 18, wherein the professional service is a health service, and the professional qualifier is provided by a licensed healthcare professional.

25. The system of claim 24, wherein the user-oriented data comprises one or more of the subject's age, sex, height, weight, known medical conditions, vital signs, test results, prior conditions, prior treatments, lifestyle habits, current and past medications, prescriptions, and family medical history.

26. The system of claim 24, wherein the system comprises a data exchange module embodied in a non-transitory computer readable storage medium for interacting with external medical data formats, wherein the user-oriented data comprises external medical data obtained from a health provider's database.

27. The system of claim 24 further comprising an external computer connection and a browser program module embodied in a non-transitory computer readable storage medium, wherein the browser program module accesses external data through the external computer connection to update the service-assessment database.

28. The system of claim 24 further comprising security measures to protect the subject's privacy, integrity of data, or both.

29. The system of claim 24, wherein the system is provided over a network.

30. The system of claim 24, wherein the system is coupled to a network.

31. The system of claim 24, wherein the user is a first individual requesting a professional service for a second individual, the user selected from the group consisting of a parent, guardian, professional service provider, or an insurance provider.

32. The system of claim 24, wherein the user indicates an absence of a professional qualifier; and, interactively and iteratively answers one or more additional queries generated by the system to develop a virtual, professional qualifier.

33. The system of claim 24, wherein the input device, the output device, or both, is provided through a portable, single unit device.

34. The system of claim 24, wherein the portable, single unit device is a handheld device.

35. A professionally-qualified bidding system, the system comprising:
a user component operable to allow a user to request a bid from a service provider for a professional service, wherein the request includes a professional-qualifier to qualify the user's request for the professional service from the service provider;
a professional component operable for the service provider to place the bid on the professional service sought by the user;
wherein,
the professional qualifier provides the professional with an available pre-screening data from a third-party professional regarding the user's need or desire for the service and the risk of performing the service.

36. The system of claim 35, wherein the professional service is a health service, and the professional qualifier is provided by a licensed healthcare professional.
